(19) United States
(12) Patent Application Publication
(10) Pub. No.: US 2020/0357361 A1
(43) Pub. Date: Nov. 12, 2020

(54) ELECTRONIC APPARATUS RECEIVING SUPPLIED POWER THROUGH SUBSTRATE COMPRISING MULTIPLE LAYERS

(71) Applicant: Samsung Electronics Co., Ltd., Gyeonggi-do (KR)

(72) Inventors: Hyun Jun PARK, Gyeonggi-do (KR); Dong Kyoon HAN, Gyeonggi-do (KR)

(21) Appl. No.: 16/640,515

(22) PCT Filed: Aug. 23, 2018
(86) PCT No.: PCT/KR2018/009726

§ 371 Date: Feb. 20, 2020

(30) Foreign Application Priority Data
Aug. 23, 2017 (KR) 10-2017-0106853

(51) Int. Cl. G09G 5/10; G09G 3/3225; H01Q 1/24

(52) U.S. Cl. CPC G09G 5/10; G09G 3/3225; G09G 2320/0633; G09G 2330/028; G09G 2330/06; H01Q 1/24

(57) ABSTRACT

According to various embodiments of the present invention, disclosed is an electronic apparatus comprising: a first surface; a second surface opposite the first surface; a housing including a side surface member which encases the space between the first surface and the second surface; a display panel arranged on at least a portion of the housing; a substrate including a first layer, a second layer, and at least one inner layer arranged between the first layer and the second layer; a display driving circuit which is electrically connected to the display panel and the substrate; and a power regulator which is electrically connected to the display driving circuit through the substrate, wherein the power regulator supplies power to the display driving circuit through the at least one inner layer so that the display driving circuit generates a gray scale voltage. Other various embodiments identified through the specification are also enabled.

### TECHNICAL FIELD

The disclosure relates to a technique for reducing a noise generated in a display or a noise input to the display.

### BACKGROUND ART

With the development of information technology (IT), various types of electronic devices including displays, such as smartphones, tablet personal computers, and the like, are widely used. The display may include a plurality of pixels, and various contents may be output to the display in response to an operation of a light emitting diode included in the pixels.

The electronic device may include a display driver integrated circuit (DDI) capable of outputting various contents to a display panel. The display driver integrated circuit may transmit an image signal to the display panel and supply voltages of various levels for the operation of an electrical element (e.g., a transistor and a light emitting diode) included in the display panel. For example, the display driver integrated circuit may receive power from a power supply to supply power to the display panel. The display driver integrated circuit may supply a gray scale voltage to the display panel based on the received power. The gray scale voltage, which is a voltage supplied to the pixels, may adjust the brightness of the pixels.

### DISCLOSURE

### Technical Problem

Various electronic elements may be included in an electronic device, and the elements may generate noises (or electromagnetic interference) of various levels in some cases. The noises may cause electrical overstress to the power supplied to the display driver integrated circuit. In this case, abnormal power may be supplied to the display driver integrated circuit, and the voltage supplied to the display panel, for example, a gray scale voltage, may have an abnormal value. Accordingly, an unstable screen, which is not intended, may be output onto the display of the electronic device.

The electromagnetic interference may also be caused by the power supplied to the display driver integrated circuit. The electromagnetic interference may have an effect on the performance of an electrical element, such as an antenna, adjacent to the display driver integrated circuit.

Aspects of the disclosure are to address at least the above-mentioned problems and/or disadvantages and to provide at least the advantages described below. Accordingly, an aspect of the disclosure is to provide an electronic device.

### Technical Solution

In accordance with an aspect of the disclosure, an electronic device includes a housing including a first surface, a second surface facing the first surface, and a side member surrounding a space between the first and second surfaces, a display panel disposed in at least a portion of the housing, a board electrically connected to at least a portion of one end of the display panel and including a first layer, a second layer, and one or more inner layers disposed between the first and second layers, a display driver integrated circuit electrically connected to the display panel and the board, and a power regulator electrically connected to the display driver integrated circuit through the board, wherein the power regulator supplies power to the display driver integrated circuit through the one or more inner layers such that the display driver integrated circuit generates a gray scale voltage.

In accordance with another aspect of the disclosure, a display includes a display panel including a plurality of pixels, a display driver integrated circuit configured to control brightness of the plurality of pixels, and a board electrically connected to one end of the display panel and including a first layer, a second layer, and one or more inner layers arranged between the first and second layers, wherein a conductive line through which the display driver integrated circuit transmits power for controlling the brightness of the pixels is arranged in the one or more inner layers.

### Advantageous Effects

According to the embodiments disclosed in the disclosure, the electronic device may stably output a specified screen to the display. In addition, according to the embodiments disclosed in the disclosure, the reception sensitivity of the antenna adjacent to the display driver integrated circuit may be improved. In addition, various effects that are directly or indirectly understood through the disclosure may be provided.

### DESCRIPTION OF DRAWINGS

FIG. 1 is a block diagram of an electronic device receiving power through a multi-layer board in a network environment according to various embodiments.

FIG. 2 is a block diagram of a display device for receiving power through a plurality of layers according to various embodiments.

FIG. 3 is an exploded perspective view of an electronic device according to an embodiment.

FIG. 4 is a view illustrating a stack structure of an electronic device according to an embodiment.

FIG. 5 is a plan view of a display according to an embodiment.

FIG. 6A is a cross-sectional view of a board according to an embodiment.

FIG. 6B is a cross-sectional view of a board according to an embodiment.

FIG. 7A is a view illustrating a power supply path of a power regulator according to an embodiment.

FIG. 7B is a view illustrating a power supply path of a power regulator according to an embodiment.

FIG. 8 is a graph illustrating a noise measurement result of an electronic device according to various embodiments.

With regard to description of drawings, similar elements may be marked by similar reference numerals.

### MODE FOR INVENTION

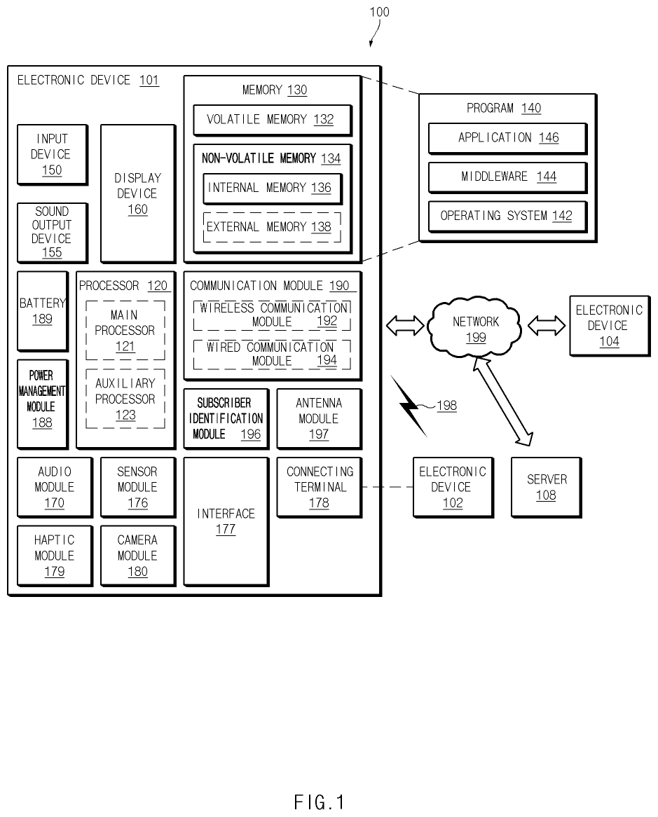

FIG. 1 is a block diagram of an electronic device receiving power through a multi-layer board in a network environment according to various embodiments.

Referring to FIG. 1, an electronic device 101 may communicate with an electronic device 102 through a first network 198 (e.g., a short-range wireless communication) or may communicate with an electronic device 104 or a server 108 through a second network 199 (e.g., a long-distance wireless communication) in a network environment 100. According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, a sensor module 176, an interlace 177, a haptic module 179, a camera module 180, a power management module 188, a battery 189, a communication module 190, a subscriber identification module 196, and an antenna module 197. According to some embodiments, at least one (e.g., the display device 160 or the camera module 180) among components of the electronic device 101 may be omitted or other components may be added to the electronic device 101. According to some embodiments, some components may be integrated and implemented as in the case of the sensor module 176 (e.g., a fingerprint sensor, an iris sensor, or an illuminance sensor) embedded in the display device 160 (e.g., a display).

The processor 120 may operate, for example, software (e.g., a program 140) to control at least one of other components (e.g., a hardware or software component) of the electronic device 101 connected to the processor 120 and may process and compute a variety of data. The processor 120 may load a command set or data, which is received from other components (e.g., the sensor module 176 or the communication module 190), into a volatile memory 132, may process the loaded command or data, and may store result data into a nonvolatile memory 134. According to an embodiment, the processor 120 may include a main processor 121 (e.g., a central processing unit or an application processor) and an auxiliary processor 123 (e.g., a graphic processing device, an image signal processor a sensor hub processor, or a communication processor), which operates independently from the main processor 121, additionally or alternatively uses less power than the main processor 121, or is specified to a specified function. In this case, the auxiliary processor 123 may operate separately from the main processor 121 or embedded.

In this ease, the auxiliary processor 123 may control, for example, at least some of functions or states associated with at least one component (e.g., the display device 160, the sensor module 176, or the communication module 190) among the components of the electronic device 101 instead of the main processor 121 while the main processor 121 is in an inactive (e.g., sleep) state or together with the main processor 121 while the main processor 121 is in an active (e.g., an application execution) state. According to an embodiment, the auxiliary processor 123 (e.g., the image signal processor or the communication processor) may be implemented as a part of another component (e.g., the camera module 180 or the communication module 190) that is functionally related to the auxiliary processor 123. The memory 130 may store a variety of data used by at least one component (e.g., the processor 120 or the sensor module 176) of the electronic device 101, for example, software (e.g., the program 140) and input data or output data with respect to commands associated with the software. The memory 130 may include the volatile memory 132 or the nonvolatile memory 134.

The program 140 may be stored in the memory 130 as software and may include, for example, an operating system 142, a middleware 144, or an application 146.

Site input device 150 may be a device for receiving a command or data, which is used for a component (e.g., the processor 120) of the electronic device 101, from an outside (e.g., a user) of the electronic device lift and may include, for example, a microphone, a mouse, or a keyboard

The sound output device 155 may be a device for outputting a sound signal to the outside of the electronic device 101 and may include, for example a speaker used for general purposes, such multimedia play or recordings play, and a receiver used only for receiving calls. According to an embodiment, the receiver and the speaker may be either integrally or separately implemented.

The display device 160 may be a device for visually presenting information to the user of the electronic device 101 and may include, for example, a display, a hologram device, or a protector and a control circuit for controlling a corresponding device. According to an embodiment, the display device 160 may include a touch circuitry or a pressure sensor for measuring an intensity of pressure on the touch.

The audio module 170 may convert a sound and an electrical signal in dual directions. According to an embodiment, the audio module 170 may obtain the sound through the input device 150 or may output the sound through an external electronic device (e.g., the electronic device 102 (e.g., a speaker or a headphone)) wired or wirelessly connected to the sound output device 155 or the electronic device 101.

The sensor module 176 may generate an electrical signal or a data value corresponding to an operating state (e.g., power or temperature) insult or an environmental state outside the electronic device 101. The sensor module 176 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidify sensor, or an illuminance sensor.

The interlace 177 may support a specified protocol wired or wirelessly connected to the external electronic device (e.g., the electronic device 102). According to an embodiment, the interface 177 may include, for example, an HDMI (high-definition multimedia interface), a USB (universal serial bus) interface, an SD card interface, or an audio interface.

A connecting terminal 178 may include a connector that physically connects the electronic device 101 to the external electronic device (e.g., the electronic device 102), for example, an HDMI connector, a USB connector, an SD card connector, or an audio connector (e.g., a headphone connector).

The haptic module 179 may convert an electrical signal to a mechanical simulation (e.g., vibration or movement) or an electrical stimulation perceived by the user through tactile or kinesthetic sensations. The haptic module 179 may include, for example, a motor, a piezoelectric element, or an electric stimulator.

The camera module 180 may shoot a still image or a video image. According to an embodiment, the camera module 180 may include, for example, at least one lens, an image sensor, an image signal processor, or a flash.

The power management module 188 may be a module for managing power supplied to the electronic device 101 and may serve as at least a part of a power management integrated circuit (PMIC).

The battery 189 may be a device for supplying power to at least one component of the electronic device 101 and may include, for example, a non-rechargeable (primary) battery a rechargeable (secondary) battery, or a fuel cell.

The communication module 190 may establish a wired or wireless communication channel between the electronic device 101 and the external electronic device (e.g., the electronic device 102, the electronic device 104, or the server 108) and support communication execution through the established communication channel. The communication module 190 may include at least one communication processor operating independently from the processor 120 (e.g., the application processor) and supporting the wired communication or the wireless communication. According to an embodiment, the communication module 190 may include a wireless communication module 192 (e.g., a cellular communication module, a short-range wireless communication module, or a GNSS (global navigation satellite system) communication module) or a wired communication module 194 (e.g., an LAN (local area network) communication module or a power line communication module) and may communicate with the external electronic device using a corresponding communication module among them through the first network 198 (e.g., the short-range communication network such as a Bluetooth, a Wifi direct, or an IrDA (infrared data association)) or the second network 199 (e.g., the long-distance wireless communication network such as a cellular network, an internet, or n computer network (e.g., LAN or WAN)). The above-mentioned various communication modules 190 may be implemented into one chip or into separate chips, respectively.

According to an embodiment, the wireless communication module 192 may identify and authenticate the electronic device 101 using user information stored in the subscriber identification module 196 in the communication network.

The antenna module 107 may include one or more antennas to transmit or receive the signal or power to or from an external source. According to an embodiment, the communication module 190 (e.g., the wireless communication module 192) way transmit or receive the signal to or from the external electronic device through the antenna suitable for the communication method.

Some components among the components may be connected to each other through a communication method (e.g., a bus, a GPIO (general purpose input/output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 101 and the external electronic device 104 through the server 108 connected to the second network 199. Each of the electronic devices 102 and 104 may be the same or different types as or from the electronic device 101. According to an embodiment, all or some of the operations performed by the electronic device 101 may be performed by another electronic device or a plurality of external electronic devices. When the electronic device 101 performs some functions or services automatically or by request, the electronic device 101 may request the external electronic device to perform at least some of the functions related to the functions or services, in addition to or instead of performing the functions or services by itself. The external electronic device receiving the request may carry out the requested function or the additional function and transmit the result to the electronic device 101. The electronic device 101 may provide the requested functions or services based on the received result as is or after additionally processing the received result. To this end, for example, a cloud computing, distributed computing, or client-server computing technology may be used.

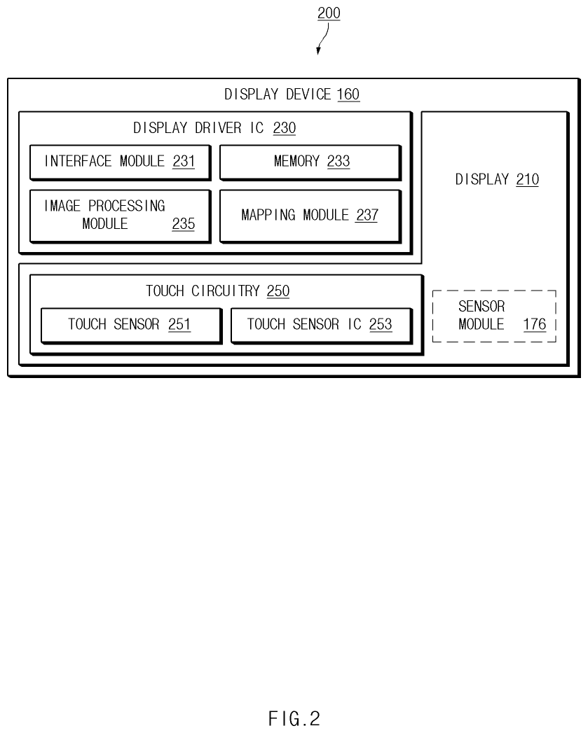

FIG. 2 is a block diagram of a display device for receiving power through a plurality of layers according to various embodiments.

Referring to FIG. 2, the display device 160 may include a display 210 and a display driver 1C (DDI) 230 for controlling the display 210. The DDI 230 may include an interface module 231, a memory 233 (e.g., a buffer memory), an image processing module 235, or a mapping module 237. For example, the DDI 230 may receive image information including image data or an image control signal corresponding to a command for controlling the image data from a processor 120 (e.g., a main processor 121 or an application processor) or art auxiliary processor 123, which is operated independently of the main processor 121, through the interface module 231. The DDI 230 may communicate with a touch circuit 250, the sensor module 176, or the like through the interface module 231. In addition, the DDI 230 may store at least a part of the received image information in the memory 233, for example, in units of frames, for example, the image process mg module 235 may perform preprocessing or post-processing (e.g., adjustment of resolution, brightness, or size) on at least a part of the image data based at least partially on characteristics of the image data or the display 210. The mapping module 237 may convert the image data preprocessed or post-processed through the image processing module 235 into a voltage value or a current value capable of driving the pixels, based at least partially on attributes of the pixels of the display 210 (e.g., an array of pixels (RGB stripe or pentile) or a size of each of subpixels) for example, at least some pixels of tire display 210 may be driven based on the voltage or current value, such that visual information (e.g., a text, an image, or an icon) corresponding to the image data is displayed on the display 210.

According to an embodiment, the display device 160 may further include the touch circuit 250. The touch circuit 250 may include a touch sensor 251 and a touch sensor IC 253 for controlling the touch sensor 251. The touch sensor IC 253 may controls the touch sensor 251 to measure, for example, a change in a signal to (e.g., a voltage a light amount, a resistance, or a charge amount) at a specific position of the display 210 to sense a touch input or a hovering input, and may provide information (e.g., a location, an area, a pressure or a time) about the sensed touch input or hovering input to the processor 120. According to an embodiment, at least a part (e.g., the touch sensor IC 253) of the touch circuit 250 may be included as a part of the display driver IC 230 or the display 210, or as a part of another component (e.g., the auxiliary processor 123) arranged outside the display device 160

According to an embodiment, the display device 160 may further include at least one sensor (e.g., a fingerprint sensor, an iris sensor, a pressure sensor or an illuminance sensor) of the sensor module 176, or a control circuitry thereof. In this case, the at least one sensor or the control circuitry thereof may be embedded m a part (e.g., the display 210 or the DDI 230) of the display device 160 or a part of the touch circuit 250. For example, when the sensor module 176 embedded in the display device 160 includes a biometric sensor (e.g., a fingerprint sensor), the biometric sensor may obtain biometric information associated with a touch input through an area of the display 210. As another example, when the sensor module 176 embedded in the display device 160 includes a pressure sensor, the pressure sensor may obtain information about a pressure corresponding to a touch input through an area or entire area of the display 210. According to an embodiment, the touch sensor 251 or the sensor module 176 may be arranged between pixels of the pixel layer of the display 210, or above or below the pixel layer.

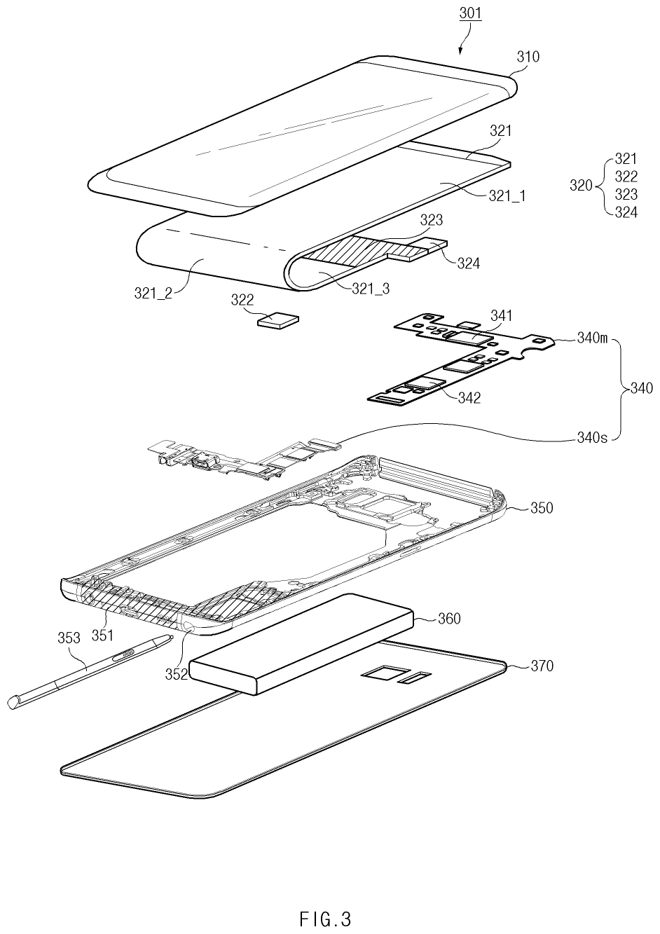

FIG. 3 is an exploded perspective view of an electronic device according to an embodiment.

Referring to FIG. 3, an electronic device 301 (e.g., the electronic device 101 of FIG. 1) according to an embodiment may include a cover glass 310, a display 320, and a circuit board 340, a side member 350, a battery 360, and or a back cover 370. The cover glass 310, the side member 350, and the back cover 370 may be coupled to each other to form a housing of the electronic device 301. According to various embodiments, the electronic device 301 may not include some components shown in FIG. 3 or may further include components not shown in FIG. 3.

According to an embodiment, the cover glass 310 may transmit light generated by the display 320 to the outside of the electronic device 301. According to another example, the cover glass 310 may transmit light outside the electronic device 301 or light generated from the electronic device 301 and reflected by an external object into the electronic device 301. For example, the cover glass 310 may transmit light reflected by a part of a user body to recognize a fingerprint pattern or an iris pattern of a user.

According to an embodiment, a user may provide a touch input (including a touch using an electronic pen) to the electronic device 301 by allowing a part (e.g., a finger) of the body to touch or approach (e.g., hovering) the cover glass 310. The cover glass 310 may be formed of, for example, tempered glass, tempered plastic, a flexible polymer material, or the like, to protect a configuration included in the display 320 and the electronic device 301 from external impact. According to various embodiments, the cover glass 310 may also be referred to as a first surface constituting a glass window or a housing of the electronic device 301.

According to an embodiment, the display 320 may be arranged in a space between the cover glass 310 and the back cover 370. For example, the display 320 may be arranged or coupled below the cover glass 310 to be exposed through at least a portion of the cover glass 310. The display 320 may output contents (e.g., text, an image, a video, an icon, a widget, a symbol, or the like), or receive an input (e.g., a touch input or an electronic pen input) from a user.

According to an embodiment, the display 320 may include a display panel 321, a board 323, a connector 324, and a display driver integrated circuit 322. According to various embodiments, the display 320 may further include some components in addition to the above-described components.

According to an embodiment, for example, the display panel 321 may include a liquid crystal display (LCD) panel, a light emitting diode (LED) display panel, an organic light emitting diode (OLED) display panel, and a microelectromechanical system (MEMS) display panel, or an electronic paper display panel.

For example, the display panel 321 may include a scan line, a data line, a light emitting device (e.g., an OLED) that generates light based on the signals supplied from the scan line and the data line, a board (e.g., a low temperature poly silicon (LTPS) board) on which the light emitting device is arranged, and/or a thin film encapsulation (TFE) for protecting the light emitting device. The light emitting device may constitute a pixel.

According to an embodiment, the display panel 321 may include a planar area 321_1 and a bent area 321_2 extending from one side (e.g., an upper side, a lower side, a left side, or a right side) of the planar area 321_1. According to an embodiment, a portion of the bent area 321_2 may be folded toward the rear surface of the planar area 321_1.

According to an embodiment, pixels (e.g., OLEDs and the like), a touch sensor, an electronic pen sensor, and or a conductive pattern thereof of the display panel 321 may be arranged in the planar area 321_1.

According to an embodiment, various conductive patterns (lines) which are capable of electrically connecting the board 323 arranged on the rear surface of the display panel 321 and various electrical elements arranged on the planar area 321_1 may be arranged in the bent area 321_2. According to various embodiments, similar to the planar area 321_1, pixels for displaying various information may be arranged in the bent area 321_2.

According to an embodiment, the display panel 321 may further include a planar area 321_3 which is distinguished from the planar area 321_1 and extends to one side in the bent area 321_2. In various embodiments, the planar area 321_1 may be referred to as the first planar area 321_1, and the planar area 321_3 may be referred to as the second planar area 321_3. In an embodiment, the second planar area 321_3 may be electrically connected to the board 323.

According to an embodiment, the board 323 may be connected to one end of the display panel 321. One end of the display panel 321 may be one end of the bent area 321_2, or may be one end of the second planar area 321_3. According to various embodiments, the board 323 may be a rigid printed circuit board (RPCB), a flexible printed circuit board (FPCB), a high density interconnection board, or an SLP (board like PCB). According to various embodiments, the board 323 may be referred to as the first board 323. According to an embodiment, the board 323 may be referred to as a substrate.

According to an embodiment, the board 323 may include a plurality of layers. For example, the board 323 may include a first layer, a second layer, and at least one inner layer arranged between the first and second layers. According to an embodiment, the at least one inner layer may include a copper layer. The first and second layers may include a copper layer and a cooper plating layer. According to an embodiment, an insulator may be included at a boundary between the first layer, the second layer, and the at least one inner layer. The electromagnetic interference between the conductors arranged in each of the layers may be reduced by the insulator.

According to an embodiment, the at least one inner layer may have a thickness thinner than that of the first or second layer. According to an embodiment, the at least one inner layer may have a width wider than that of the first or second layer to compensate for the high impedance due to the relatively thin thickness. According to various embodiments, the width of the board 323 may be widened within a limit area of the electronic device 301 to compensate for the high impedance of the entire layer including the at least one inner layer, and the first and second layers.

According to an embodiment, the connector 324 may be attached to one end of the board 323. The connector 324 may interconnect the conductors arranged on the board 323 and the circuit board 340. According to various embodiments, an electrical element (e.g., a power regulator 341) arranged on the circuit board 340 may be electrically connected to the board 323 by the connector 324.

According to an embodiment, the display driver integrated circuit 322 may be electrically connected to the display panel 321 and control the turning on or off of the pixels included in the display panel 321. In an embodiment, the display driver integrated circuit 322 may control the brightness of the pixels by changing the intensity of the gray scale voltage supplied to the display panel 321. In another embodiment, the display driver integrated circuit 322 may receive image data from a processor (host) and supply a signal corresponding to the image data to the display panel 321 at the set number of frames.

According to an embodiment, the display driver integrated circuit 322 may be arranged in a specified area of the display panel 321. For example, the display driver integrated circuit 322 may be arranged in a specified area between the bent area 321_2 and the board 323 of the display panel 321. As still another example, the display driver integrated circuit 322 may be arranged in a specified area of the second planar area 321_3 of the display panel 321. According to various embodiments, the bent area 321_2 and the second planar area 321_3 of the display panel 321 may be formed of a separate film. In this case, the display driver integrated circuit 322 may be arranged in the specified area on the separate film.

According to an embodiment, the circuit board 340 may include, for example, a main circuit board 340m or a sub circuit board 340s. According to an embodiment, the main circuit board 340m and the sub circuit board 340s may be arranged between the board 323 and the back cover 370. The main circuit board 340m and the sub circuit board 340s may be electrically connected to each other through a specified connector or a specified line. The circuit boards 340m and 340s may be implemented with, for example, a rigid printed circuit board or a flexible printed circuit board. According to various embodiments, the circuit board 340 may be referred to as the second board 340 corresponding to the first board 323 (board 323).

According to an embodiment, the circuit boards 340m and 340s may include the power regulator 341, a wireless communication circuit 342, or a processor (not shown). According to various embodiments, in addition to the above-mentioned components, various electronic components, elements, and printed circuits of the electronic device 301 may be mounted or arranged on the circuit boards 340m and 340s. According to various embodiments, the circuit boards 340m and 340s may be referred to as a main board, a printed board assembly (PBA), or simply a PCB.

According to an embodiment, the power regulator 341 may supply power to an electrical element included in the electronic device 301. For example, the power regulator 341 may supply power to the display driver integrated circuit 322 such that the display driver integrated circuit 322 generates a gray scale voltage. The power regulator 341 may be electrically connected to the display driver integrated circuit 322 through the board 323.

According to an embodiment, the power regulator 341 may supply power to the display driver integrated circuit 322 through a conductive line arranged on at least one inner layer of the board 323. Because the at least one inner layer is surrounded by a plurality of layers including an insulator, the power supplied to the display driver integrated circuit 322 may be protected from external electromagnetic interference. In addition, the electromagnetic interference caused by the conductive lines arranged on the at least one inner layer may be prevented from being radiated to an outside by the plurality of layers including the insulator.

According to an embodiment, the wireless communication circuit 342 may be electrically connected to an antenna element 351 included in the side member 350. In an embodiment, the wireless communication circuit 342 may feed power to the antenna element 351 and transmit and receive a signal of a specified frequency band by using an electrical path formed through the antenna element 351.

According to an embodiment, the side member 350 may be arranged between the circuit board 340 and the back cover 370 to accommodate the components of the electronic device 301. For example, the side member 350 may be coupled to the back cover 370 of the electronic device 301. The side member 350 may surround a space between the cover glass 310 and the back cover 370. According to various embodiments, a hole 352 extending lengthwise and inwardly of the side member 350 may be formed in a portion of the side member 350. For example, the hole may accommodate an electronic pen (stylus pen) 353.

According to an embodiment, the side member 350 may include the antenna element 351. The antenna element 351 may include at least a portion of the side member 350. According to an embodiment, the antenna element 351 may be powered by the wireless communication circuit 342 to transmit and receive a signal of a specified frequency band.

According to an embodiment, the influence of the electromagnetic interference that the antenna element 351 receives from the board 323 may be less than or equal to a specified level. Because at least one inner layer of the board 323 is surrounded by a plurality of layers including an insulator, the electromagnetic interference may be less than or equal to a specified level. In other words, a decrease in the performance of the antenna element 351 due to electromagnetic interference caused by the board 323 may be prevented.

According to an embodiment, the battery 360 may convert chemical energy to electrical energy and vice versa. For example, the battery 360 may convert chemical energy into electrical energy and supply the electrical energy to various configurations or modules mounted on the display 320 and the circuit board 340. As another example, the battery 360 may convert electrical energy supplied from an outside into chemical energy and store it.

According to an embodiment, the back cover 370 may be coupled to the rear surface of the electronic device 301. The back cover 370 may be formed of tempered glass, plastic injection molding, and/or metal. According to various embodiments, the back cover 370 may be integrated with the side member 350 or may be implemented to be detachable by a user. The back cover 370 may be referred to as a second surface constituting a rear case, a rear plate or a housing.

In the disclosure, the contents described with reference to FIG. 3 may be identically applied to the components having the same reference numerals as those of the electronic device 300 illustrated in FIG. 3.

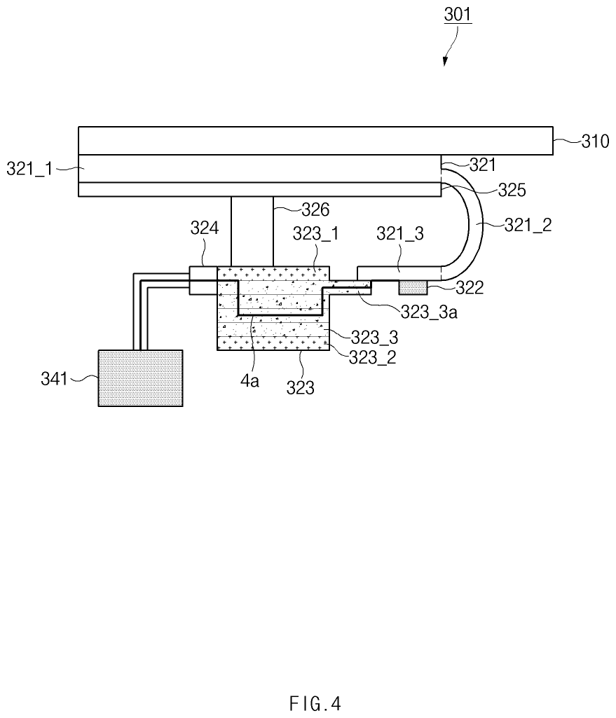

FIG. 4 is a view illustrating a stack structure of an electronic device according to an embodiment.

Referring to FIG. 4, a path through which power supplied from the power regulator 341 to the display driver integrated circuit 322 is transmitted is illustrated. According to an embodiment, the electronic device 301 may include the cover glass 310, the display panel 321, the display driver integrated circuit 322, the first board 323, the connector 324, a metal plate layer 325, and a conductive layer 326, and the power regulator 341. According to various embodiments, some of the above-mentioned components may be omitted or some components not illustrated in FIG. 4 may be added to the electronic device 301 illustrated in FIG. 4. In the description of FIG. 4, contents overlapping with the description of FIG. 3 may be omitted.

For example, the metal plate layer 325 may include a copper (Cu) and/or graphite layer. According to an embodiment, the metal plate layer 325 may prevent electromagnetic interference that may occur from a plurality of pixels included in the display panel 321. The metal plate layer 325 may reduce the influence of the electromagnetic interference on the signals transmitted to the first board 323.

The conductive layer 326 may electrically connect the metal plate layer 325 and the first board 323. The conductive layer 326 may electrically connect the metal plate layer 325 with a ground terminal of the board 323.

The first board 323 may be connected to the power regulator 341 and the display panel 321. In an embodiment, the first board 323 may be connected to the power regulator 341 through the connector 324. In an embodiment, the first board 323 may be connected to the display panel 321 through at least one inner layer included in the first board 323.

According to an embodiment, the first board 323 may include a first layer 323_1, a second layer 323_2, and at least one inner layer 323_3 between the first and second layers 323_1 and 323_2. According to an embodiment, one inner layer 323_3a among the at least one inner layer 323_3 may extend toward the display panel 321. In this case, it may be understood that the one inner layer 323_3a protrudes from the plurality of layers 323_1, 323_2 and 323_3 included in the first board 323 toward the display panel 321.

According to an embodiment, a plurality of signals transmitted through the plurality of layers 323_1, 323_2 and 323_3 included in the first board 323 may be transmitted through mutually different layers in at least some areas of the first board 323. The plurality of signals may be transmitted through the same layer in another area (e.g., an area in which one of the inner layers 323_3a extends) different from the at least some areas. For example, the plurality of signals may be transmitted through the one inner layer 323_3a that extends in an area where the one inner layer 323_3a extends.

According to an embodiment, the power regulator 341 may supply power to the display driver integrated circuit 322. The supplied power may be transmitted through at least one inner layer of the first board 323. For example, the power may be transmitted through the innermost inner layer.

According to an embodiment, the power supplied from the power regulator 341 to the display driver integrated circuit 322 may be transmitted through the plurality of inner layers 323_3. For example, the power may be transmitted through a first inner layer in at least some areas of the first board 323, and may be transmitted through a second inner layer in an area different from the at least some areas. According to an embodiment, the second inner layer may be the inner layer 323_3a extending from the first board 323 toward the display panel 321.

According to an embodiment, the transmission path of the power supplied from the power regulator 341 to the display driver integrated circuit 322 may be the same as or similar to a transmission path 4a. The transmission path 4a may be connected to the display driver integrated circuit 322 by passing from the power regulator 341 through at least one inner layer of the first board 323 and passing through any one extended inner layer 325_3a.

According to an embodiment, various electromagnetic interferences may occur outside the first board 323. For example, various electrical elements (e.g., the power regulator 341) may be arranged on a second board (e.g., the circuit board 340 of FIG. 3) that may be arranged below the first board 323. When current flows through the electrical elements arranged on the second board 340, electromagnetic interference may be caused in the second board 340. As another example, a plurality of pixels may be arranged in the planar area 321_1 of the display panel 321, and when current flows through the plurality of pixels, electromagnetic interference may be caused in the planar area 321_1 of the display panel 321.

According to an embodiment, the electromagnetic interference measured in the at least one inner layer 323_3 of the first board 323 may be measured at a specified value or less. Because the first board 323 includes a plurality of layers (e.g., the first and second layers 323_1 and 323_2) including an insulator, the first board 323 may be protected from the various electromagnetic interferences.

According to an embodiment, electrical overstress that may occur in the power supplied by the power regulator 341 to the display driver integrated circuit 322 may be measured at a specified value or less. Because there is little electromagnetic interference in the inner layer 323_3 of the first board 323, the electrical overstress that may occur in the power supply may be equal to or less than a specified level.

As described above, the power supplied to the display driver integrated circuit 322 may be protected from electromagnetic interference, and may be stably transmitted to the display driver integrated circuit 322. When the supplied power is stable, the gray scale voltage supplied by the display driver integrated circuit 322 to the display panel 321 may be in a normal output range, and an abnormal screen may be prevented from being output to the display panel 321.

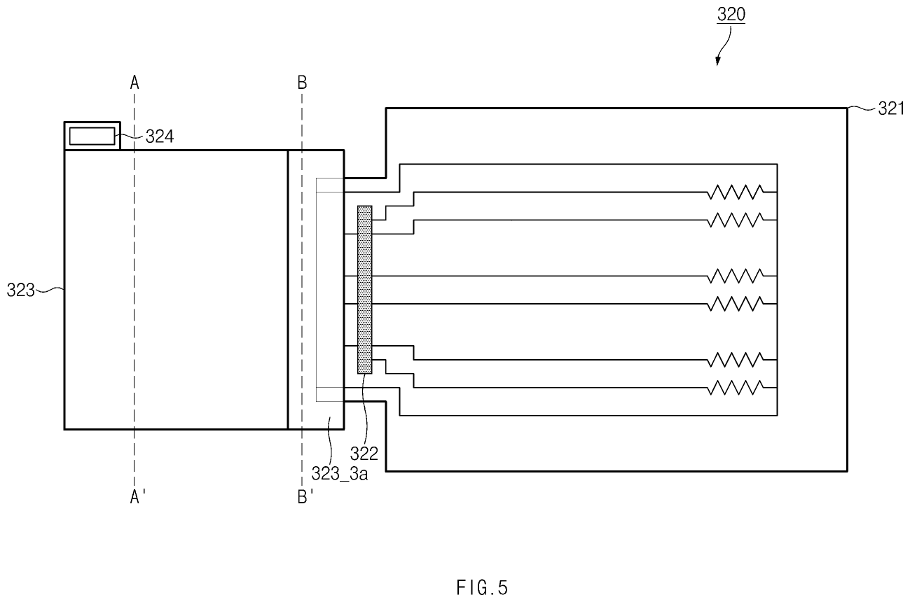

FIG. 5 is a plan view of a display according to an embodiment.

Referring to FIG. 5, the display 320 may include the display panel 321, the board 323, the connector 324, and the display driver integrated circuit 322.

According to an embodiment, the display panel 321 may include the planar area 321_1 and the bent area 321_2. It may be understood that the display panel 321 illustrated in FIG. 5 is in a state where the bent area 321_2 is unfolded. A plurality of pixels may be arranged in the planar area, and each of the pixels may be electrically connected to the display driver integrated circuit 322 through a plurality of conductive lines.

According to an embodiment, the board 323 may be connected to the display panel 321. According to various embodiments, the board 323 may have various forms. For example, the board 323 may be substantially rectangular-shaped when viewed from above. As another example, the board 323 may have a shape in which the inside of the rectangle is partially recessed when viewed from above to secure a space in which the battery 360 of the electronic device 301 is arranged. In other words, an area corresponding to line A-A′ of the board 323 illustrated in FIG. 5 may have a width narrower than that of an area corresponding to line B-B′.

In an embodiment, the board 323 may have the at least one inner layer 323_3a extending toward the display panel 321. In an embodiment, the board 323 may be connected to the display panel 321 through the at least one inner layer 323_3a extended.

According to an embodiment, the plurality of conductive lines arranged on the board 323 may be connected to the display driver integrated circuit 322. According to an embodiment, the plurality of conductive lines may be arranged on the surface of the display panel 321 in the bent area 321_2 of the display panel 321. According to an embodiment, the display panel 321 may include a flexible board, and the plurality of conductors may be arranged on the flexible board.

According to an embodiment, the connector 324 may be attached to one side of the board 323. The connector 324 may be connected to a circuit board (e.g., the circuit board 340 of FIG. 3), and the connector 324 may electrically connect the circuit board 340 and the board 323.

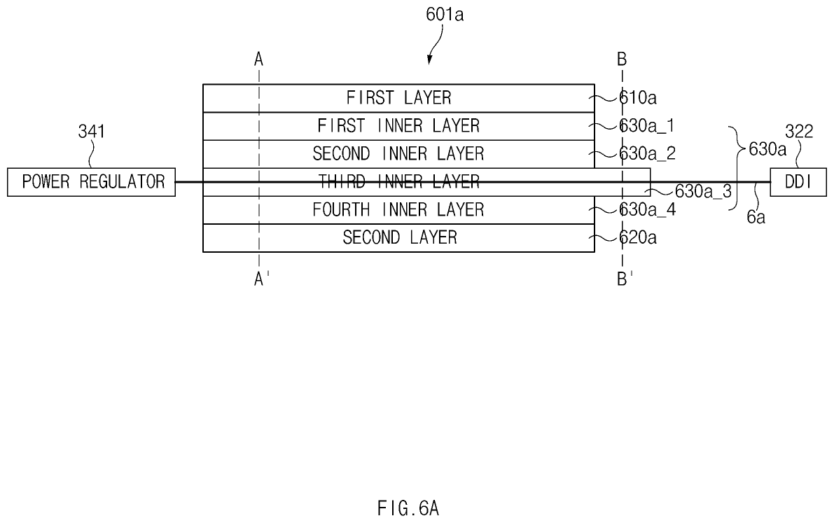

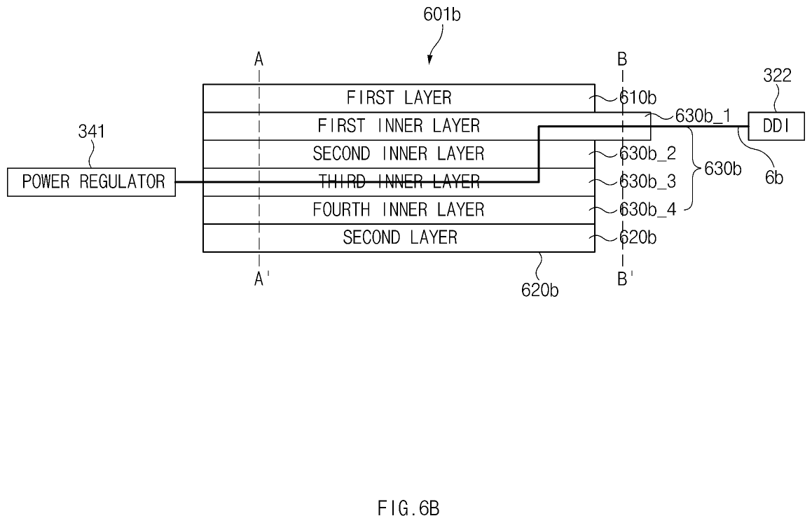

FIGS. 6A and 6B are cross-sectional views of a board according to an embodiment.

Referring to FIGS. 6A and 6B, the path of the power transmitted from the power regulator 341 to the display driver integrated circuit 322 according to various embodiments may be checked. The line A-A′ and the line B-B′ shown in FIGS. 6A and 6B may correspond to the line A-A′ and the line B-B′ shown in FIG. 5, respectively.

According to various embodiments, a board 601a or 601b may electrically connect the power regulator 341 and the display driver integrated circuit 322. According to various embodiments, the board 323 may include a plurality of inner layers 630a or 630b. For example, four inner layers 630a or 630b may be included between a first layer 610a or 610b and a second layer 620a or 620b.

According to an embodiment, any one of the inner layers 630a and 630b included in the boards 601a and 601b may extend in the direction of the display panel (e.g., the display panel 321 of FIG. 3). For example, the third inner layer 630a_3 of the board 601a may extend toward the display panel 321.

According to an embodiment, the extended third inner layer 630a_3 may be connected to the display panel 321. Because the third inner layer 630a_3 protrudes, the connection with the display panel 321 may be easier. An anisotropic conductive film (ACF) may be arranged in the extended portion of the third inner layer 630a_3 to electrically connect with the display panel 321 (or a separate film connected with the display panel 321).

According to an embodiment, the power supplied from the power regulator 341 to the display driver integrated circuit 322 may be transmitted to the display driver integrated circuit 322 through one inner layer 630a of the board 601a. For example, the power may be transmitted to the display driver integrated circuit 322 through the third inner layer 630a_3 in the same or similar manner as a first path 6a shown in FIG. 6A. In an embodiment, the third inner layer 630a_3 may be surrounded by a plurality of layers including an insulator (e.g., the first or second layer 610a or 620a), and thus may be protected from external electromagnetic interference.

According to an embodiment, the power supplied from the power regulator 341 to the display driver integrated circuit 322 may be transmitted to the display driver integrated circuit 322 through the plurality of inner layers 630b. For example, in the same or similar manner as a second path 6b shown in FIG. 6B, the power may be transmitted from the power regulator 341 through the third inner layer 630b_3 of the board 601b and to the display driver integrated circuit 322 through the first inner layer 630b_1. The power may be transmitted through a conductive line arranged on the board 601b, and the conductive line may be connected from the third inner layer 630b_3 to the first inner layer 630b_1.

According to an embodiment, the power supplied from the power regulator 341 to the display driver integrated circuit 330 may be less affected by electromagnetic interference outside the board 601a or 601b. For example, the electromagnetic interference generated from a second board (e.g., the circuit board 340 of FIG. 3), which may be arranged below the board 601a or 601b, may be measured at a specified value or less in the first inner layer 630a_1 or 630b_1 or the third inner layer 630a_3 or 630b_3.

According to an embodiment, the power supplied from the power regulator 341 to the display driver integrated circuit 322 may be transmitted to the display driver integrated circuit 322 with a stable value. For example, the electrical overstress occurring in the power may be measured at a specified value or less. As the result, the display driver integrated circuit 322 may generate a stable gray scale voltage, and the electronic device may prevent an abnormal screen from being output.

According to an embodiment, the electromagnetic interference caused by the power supplied from the power regulator 341 to the display driver integrated circuit 322 may not affect the performance of an electrical element outside the board 601a or 601b. For example, electromagnetic interference may be measured at a specified level or less in an antenna element (e.g., the antenna element 351 of FIG. 3) adjacent to the board 601a or 601b. The electromagnetic interference below the specified level may not affect the performance of the antenna element.

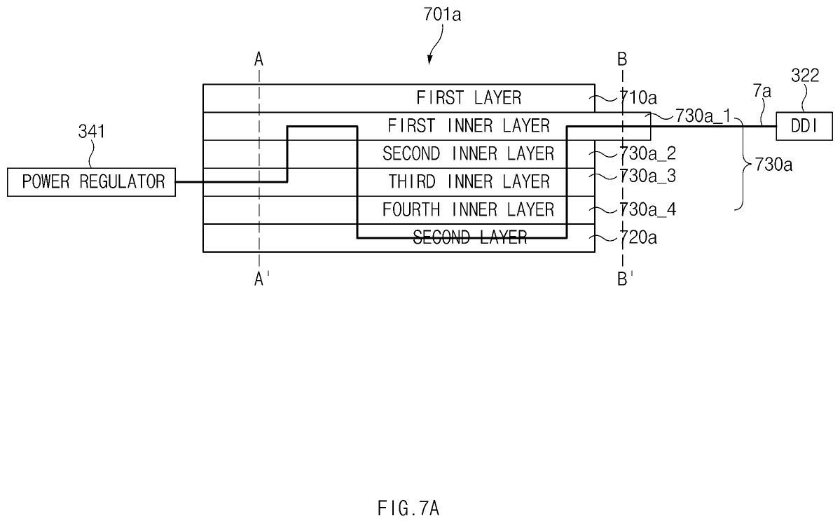

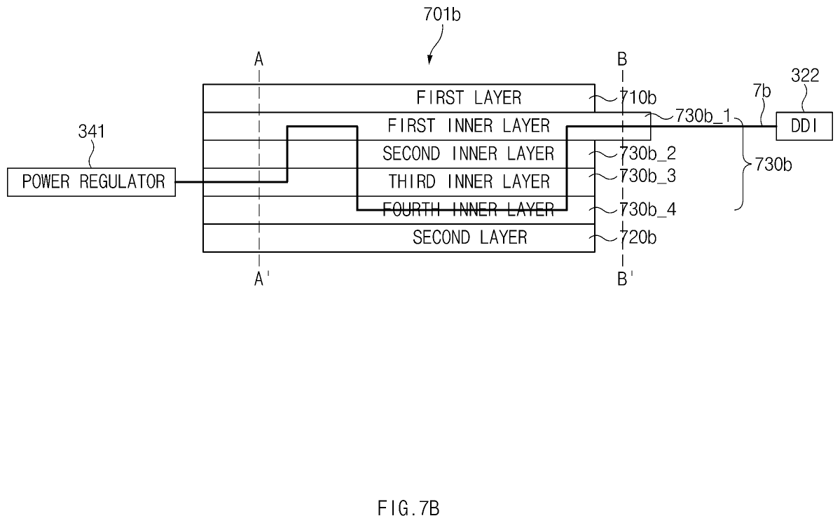

FIGS. 7A and 7B are views illustrating a power supply path of a power regulator according to an embodiment.

Referring to FIGS. 7A and 7B, comparison between performances of an electronic device depending on paths of power supplied from the power regulator 341 to the display driver integrated circuit 322 may be performed. Lines A-A′ and B-B′ illustrated in FIGS. 7A and 7B may correspond to lines A-A′ and B-B′ illustrated in FIG. 5, respectively.

According to various embodiments, the power supplied from the power regulator 341 to the display driver integrated circuit 322 may be transmitted through various paths.

According to an embodiment, the power may be transmitted in the same or similar manner as a first path 7a illustrated in FIG. 7A. For example, the power may sequentially pass through a third inner layer 730a_3, a first inner layer 730a_1, a second layer 720a, and the first inner layer 730a_1, thereby being transmitted from the power regulator 341 to the display driver integrated circuit 322.

According to an embodiment, the power may be transmitted in the same or similar manner as a second path 7b illustrated in FIG. 7B. For example, the power may sequentially pass through a third inner layer 730b_3, a first inner layer 730b_1, a forth inner layer 730b_4, and the first inner layer 730b_1, thereby being transmitted from the power regulator 341 to the display driver integrated circuit 322.

An artificially electromagnetic interference signal may be experimentally generated outside of the board 701a or 701b due to the first or second path 7a or 7b. The magnitude of the electromagnetic interference signal, which starts to generate electrical overstress equal to or greater than a specified value in the power is shown in Table 1 below. It may be understood that the power is maintained at a relatively more stable value when transmitted in the second path 7b. According to an experiment result, it may be more advantageous that the power is transmitted through the inner layer 730a or 730b than the first layer 710a or 710b or the second layer 720a or 720b.

TABLE 1

| Path | First path 7a | Second path 7b |
|---|---|---|
| Electromagnetic interference signal (kV) | 2.3 | 3.0 |

According to an embodiment, the power may be transmitted through the first layer 710a or the second layer 720a due to impedance matching or the like, as illustrated in FIG. 7A. In this case, a ground layer may be additionally arranged at a periphery of the first or second layer 710a or 720a, or an insulator included in each layer may be added, thereby reducing the influence of noise on the power.

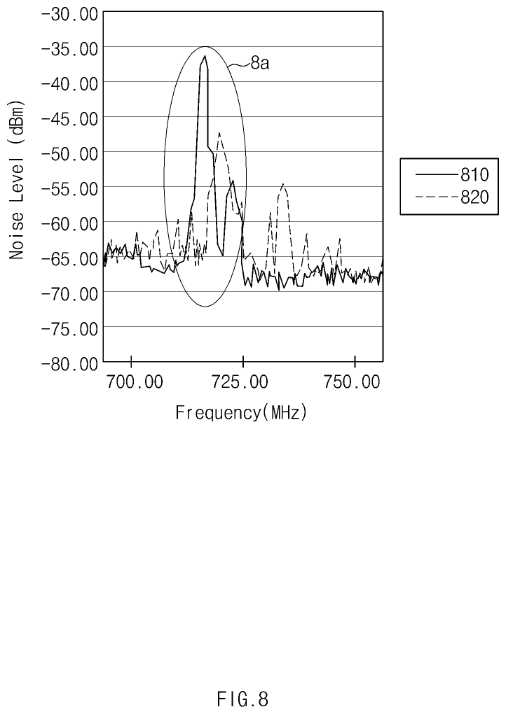

FIG. 8 is a graph illustrating a noise measurement result of an electronic device according to various embodiments.

Referring to FIG. 8, a noise level measured at a display driver integrated circuit (e.g., the display driver integrated circuit 322 of FIG. 3) is illustrated. According to an embodiment, a first graph 810 may illustrate a case where the power supplied from a power regulator (e.g., the power regulator 341 of FIG. 3) to the display driver integrated circuit 322 is transmitted through an inner layer (e.g., the inner layer 323_3 of FIG. 4) of a board (e.g., the board 323 of FIG. 3). For example, the first graph 810 may illustrate a case where the power is transmitted through the second path 7a illustrated in FIG. 7A. A second graph 820 may illustrate a case where the power is transmitted through a second layer (e.g., the second layer 323_2 of FIG. 4) of the board 323. For example, the second graph 820 may illustrate a case where the power is transmitted through the first path 7b illustrated in FIG. 7B.

According to an embodiment, a specific area 8a illustrated in FIG. 8 may illustrate a noise included in the gray scale voltage signal transmitted from the display driver integrated circuit 322 to the display panel (e.g., the display panel 321 of FIG. 3).

Referring to the first graph 810, the noise level included in the gray scale voltage signal may be measured at a maximum of about −37 dBm. Referring to the second graph 820, the noise level included in the gray scale voltage signal may be measured at a maximum of about −47 dBm. When the power supplied from the power regulator 341 to the display driver integrated circuit 322 is transmitted through the inner layer 323_3 of the board 323, the noise level may be reduced by about 10 dBm.

As a result, when the power supplied from the power regulator 341 to the display driver integrated circuit 322 is transmitted through the inner layer 323_3, it may be understood that the gray scale voltage is transmitted to the display panel 321 at a more stable value.

According to the embodiments disclosed in the disclosure, in an electronic device including a display panel, electromagnetic interference that may occur in the power supplied to the display driver integrated circuit may be reduced by changing the transmission path of the power. Accordingly, the electronic device may provide a stable screen output to a user.

According to the embodiments disclosed in the disclosure, electromagnetic interference that may occur in the power supplied to the display driver integrated circuit may be reduced by changing the transmission path of the power. Accordingly, various electrical elements included in the electronic device, for example, antenna elements, may not be reduced in performance due to the electromagnetic interference. For example, the reception sensitivity of the antenna element may be maintained above a specified level.

An electronic device according to an embodiment may include a housing including a first surface, a second surface facing the first surface, and a side member surrounding a space between the first and second surfaces, a display panel arranged in at least a portion of the housing, a board electrically connected to at least a portion of one end of the display panel and including a first layer, a second layer, and one or more inner layers arranged between the first and second layers, a display driver integrated circuit electrically connected to the display panel and the board, and a power regulator electrically connected to the display driver integrated circuit through the board, wherein the power regulator supplies power to the display driver integrated circuit through the one or more inner layers such that the display driver integrated circuit generates a gray scale voltage.

According to an embodiment, the one or more inner layers may include a first inner layer and a second inner layer, and the power regulator may supply power to the display driver integrated circuit through the first inner layer in at least an area of the board and through the second inner layer in another area different from the at least an area, such that the display driver integrated circuit generates the gray scale voltage.

According to an embodiment, the second inner layer may extend toward the display panel, at least a portion of the extending second inner layer may be connected to the display panel, and the another area different from the at least an area may include an area extending from the second inner layer.

According to an embodiment, the display panel may include at least one bent area, and the display driver integrated circuit may be arranged in an area specified among areas between the at least one bent area and the board.

According to an embodiment, the at least one inner layer may have a thickness in a specified range, which is thinner than a thickness of the first or second layer.

According to an embodiment, the at least one inner layer may have a width in a specified range, which is wider than a width of the first or second layer.

According to an embodiment, the board may include a flexible printed circuit board.

According to an embodiment, the board may correspond to a first board, and the electronic device may further include a second board arranged between the first board and the second surface.

According to an embodiment, the power regulator may be arranged on the second board, and the electronic device may further include a connector configured to connect the power regulator and the first board.

According to an embodiment, electromagnetic interference occurring in at least a portion of the second board may be measured in the at least one inner layer at a specified value or less.

According to an embodiment, an electrical overstress occurring in the power supplied from the power regulator to the display driver integrated circuit may be measured at a value in a specified range or less.

According to an embodiment, the electronic device may further include an antenna element including at least a portion of the side member, and a wireless communication circuit electrically connected to the antenna element.

According to an embodiment, the wireless communication circuit may feed power to the antenna element and transmit and receive a signal in a specified frequency band by using an electric path formed through the antenna element.

According to an embodiment, electromagnetic interference between the antenna element and the board may be equal to or less than a specified level.

A display according to an embodiment may include a display panel including a plurality of pixels, a display driver integrated circuit to control brightness of the plurality of pixels, and a board electrically connected to one end of the display panel and including a first layer, a second layer, and one or more inner layers arranged between the first and second layers, wherein a conductive line through which the display driver integrated circuit transmits power for controlling the brightness of the pixels is arranged in the one or more inner layers.

According to an embodiment, the one or more inner layers may include first and second inner layers, and the conductive line may be arranged on the first inner layer in at least some areas of the board and on the second inner layer in an area different from the at least some areas.

According to an embodiment, the second inner layer may extend toward the display panel, at least a portion of the extending second inner layer may be connected to the display panel, and the another area different from the at least an area may include an area extending from the second inner layer.

According to an embodiment, the display panel may include at least one bent area, and the display driver integrated circuit may be arranged in an area specified among areas between the at least one bent area and the board.

According to an embodiment, the at least one inner layer may have a thickness in a specified range, which is thinner than a thickness of the first or second layer.

According to an embodiment, the at least one inner layer may have a width in a specified range, which is wider than a width of the first or second layer.

The electronic device according to various embodiments disclosed in the disclosure may be various types of devices. The electronic device may include, for example, at least one of a portable communication device (e.g., a smartphone), a computer device, a portable multimedia device, a mobile medical appliance, a camera, a wearable device, or a home appliance. The electronic device according to an embodiment should not be limited to the above-mentioned devices.

It should be understood that various embodiments and terms used in the embodiments do not intend to limit technologies disclosed in the disclosure to the particular forms disclosed herein; rather, the disclosure should be construed to cover various modifications, equivalents, and/or alternatives of embodiments of the disclosure. With regard to description of drawings, similar components may be assigned with similar reference numerals. As used herein, singular forms may include plural forms as well unless the context clearly indicates otherwise. In the disclosure disclosed herein, the expressions “A or R”, “at least one of A or/and B”, “A, B, or C” or “one or more of A, B, or/and C”, and the like used herein may include any and all combinations of one or more of the associated listed items. The expressions “a first”, “a second”, “the first”, or “the second”, used in herein, may refer to various components regardless of the order and/or the importance, but do not limit the corresponding components. The above expressions are used merely for the purpose of distinguishing a component from the other components. It should be understood that when a component (e.g., a first component) is referred to us being (operatively or communicatively) “connected,” or “coupled,” to another component (e.g., a second component), it may be directly connected or coupled directly to the other component or any other component (e.g., a third component) may be interposed between them.

The term “module” used herein may represent, for example, a unit including one or more combinations of hardware, software and firmware. The term “module” may be interchangeably used with the terms “logic”/“logical block”, “part” and “circuit”. The “module” may be a minimum unit of an integrated part, or may be a part thereof. The “module” may be a minimum unit for performing one or more functions or a part thereof. For example, the “module” may include an application-specific integrated circuit (ASIC).

Various embodiments may be implemented by software (e.g., die program 140) including an instruction stored in a machine-readable storage media (e.g., an internal memory 136 or an external memory 138) readable by a machine (e.g., a computer). The machine may be a device that calls the instruction from the machine-readable storage media and operates depending on the called instruction and may include the electronic device (e.g., the electronic device 101). When the instruction is executed by the processor (e.g., the processor 120), the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the ease of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included. Alternatively or additionally, some components (e.g., the module or the program) may be integrated in one component and may perform the same or similar functions per formed by each corresponding components prior to the integration. Operations performed by a module, a programming, or other components according to various embodiments may be executed sequentially, in parallel, repeatedly or in a heuristic method. Also, at least some operations may be executed in different sequences, omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
a housing including a first surface, a second surface facing the first surface, and a side member surrounding a space between the first surface and the second surface;
a display panel disposed in at least a portion of the housing;
a board electrically connected to at least a portion of one end of the display panel and including a first layer, a second layer, and one or more inner layers disposed between the first layer and the second layer;
a display driver integrated circuit electrically connected to the display panel and the board; and
a power regulator electrically connected to the display driver integrated circuit through the board,
wherein the power regulator supplies power to the display driver integrated circuit through the one or more inner layers such that the display driver integrated circuit generates a gray scale voltage.

2. The electronic device of claim 1, wherein the one or more inner layers include a first inner layer and a second inner layer, and
wherein the power regulator supplies the power to the display driver integrated circuit through the first inner layer in at least an area of the board and through the second inner layer in another area different from the at least an area, such that the display driver integrated circuit generates the gray scale voltage.

3. The electronic device of claim 2, wherein the second inner layer extends toward the display panel,
wherein at least a portion of the extending second inner layer is connected to the display panel, and
wherein the another area different from the at least an area includes an area extending from the second inner layer.

4. The electronic device of claim 1, wherein the display panel includes at least one bent area, and
wherein the display driver integrated circuit is arranged in an area specified among areas between the at least one bent area and the board.

5. The electronic device of claim 1, wherein the at least one inner layer has a thickness in a specified range, which is thinner than a thickness of the first layer or the second layer.

6. The electronic device of claim 5, wherein the at least one inner layer has a width in a specified range, which is wider than a width of the first layer or the second layer

7. The electronic device of claim 1, wherein the board includes a flexible printed circuit board.

8. The electronic device of claim 1, wherein the board corresponds to a first board, and
wherein the electronic device further includes a second board arranged between the first board and the second surface.

9. The electronic device of claim 8, wherein the power regulator is disposed on the second board, and
wherein the electronic device further includes a connector configured to connect the power regulator and the first board.

10. The electronic device of claim 8, wherein electromagnetic interference occurring in at least a portion of the second board is measured in the at least one inner layer at a specified value or less.

11. The electronic device of claim 1, wherein an electrical overstress occurring in the power supplied from the power regulator to the display driver integrated circuit is measured at a value in a specified range or less.

12. The electronic device of claim 1, further comprising:
an antenna element including at least a portion of the side member; and
a wireless communication circuit electrically connected to the antenna element.

13. The electronic device of claim 12, wherein the wireless communication circuit is configured to feed power to the antenna element and transmit and receive a signal in a specified frequency band by using an electric path formed through the antenna element.

14. The electronic device of claim 13, wherein electromagnetic interference between the antenna element and the board is equal to or less than a specified level.
